(19) United States
(12) Patent Application Publication
(10) Pub. No.: US 2004/0093776 A1
(43) Pub. Date: May 20, 2004

(54) Ornamental motion display toy

(76) Inventor: Yung ching Laun, Ta Pei (TW)

Correspondence Address: PRO-TECHTOR INTERNATIONAL, 20775 Norada Court, Saratoga, CA, 95070-3018, US

(21) Appl. No.: 10/299,770

(22) Filed: Nov. 18, 2002

(51) Int. Cl. G09F 19/00; A63H 3/20; A63H 13/00

(52) U.S. Cl. 40/409; 446/330; 40/411

(57) ABSTRACT

An ornamental motion display toy is constructed to include a base, a holder supported on the base to hold a driven member and a display item on the driven member, a transparent container sealed to the holder to hold a liquid, a pressure regulator adapted to control the inside pressure of the container, and a driving mechanism located on the base and adapted to move the driven member and the display item in the liquid inside the transparent container.

### BACKGROUND OF THE INVENTION

1. Field of the Invention

The present invention relates to display toys and, more particularly, to an ornamental motion display toy, which uses a driving mechanism (which can be hand-operated or electrically operated) to move a display item in a transparent water container, and a pressure regulator to control the inside pressure of the transparent water container.

2. Description of the Related Art

There are commercially available display toys commonly comprised of a spherical glass water container, a rubber stopper, which seals the spherical glass water container, a display item disposed in water inside the spherical glass water container, a base, which supports the spherical glass water container, and a musical box located on the base and adapted to play certain tunes when opened. These display toys are less attractive because they cannot move the display item when the musical box playing tunes. Further, the spherical glass water container may break when the ambient temperature changed sharply during its delivery.

### SUMMARY OF THE INVENTION

The present invention has been accomplished under the circumstances in view. It is one object of the present invention to provide an ornamental motion display toy, which moves the display item and plays certain tunes when started. It is another object of the present invention to provide an ornamental motion display toy, which automatically regulates the inside air pressure of the transparent container thereof, preventing damage of the transparent container due to a sharp temperature change. According to one aspect of the present invention, the ornamental motion display toy comprises a base, a transparent holder supported on the base to hold a driven member and a display item on the driven member, a transparent container sealed to the holder to hold a liquid, a pressure regulator adapted to control the inside pressure of the container, and a driving mechanism located on the base and adapted to move the driven member and the display item in the liquid inside the transparent container. According to another aspect of the present invention, the driving mechanism can be a musical box or motor drive. According to still another aspect of the present invention, a decorating lamp set may be installed in the transparent holder, and controlled to produce a lighting effect when the driving mechanism moving the display item in the liquid inside the transparent container.

### BRIEF DESCRIPTION OF THE DRAWINGS

FIG. 1 illustrates the outer appearance of an ornamental motion display toy according to the present invention.

FIG. 2 is an exploded view of the ornamental motion display toy according to the present invention.

FIG. 3 is a sectional elevation of a part of the ornamental motion display toy according to the present invention.

FIG. 4 is a sectional plain view of the ornamental motion display toy according to the present invention.

FIG. 5 is a perspective view of the ornamental motion display toy according to the present invention.

### DETAILED DESCRIPTION OF THE PREFERRED EMBODIMENT

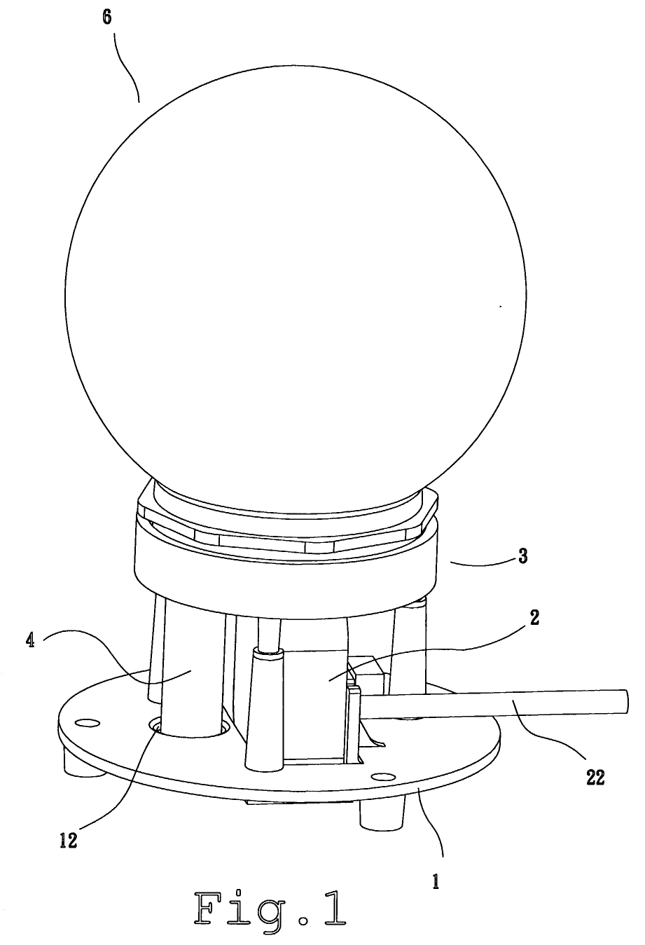

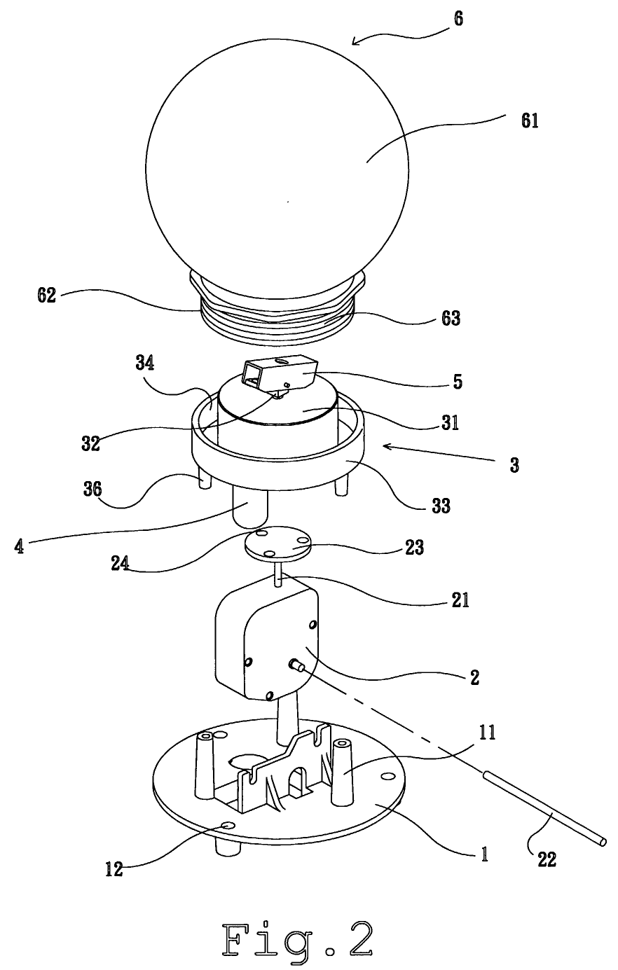

Referring to FIGS. 1 and 2, an ornamental motion display toy in accordance with the present invention is shown comprising a base 1, a driving mechanism 2 located on the base 1, a holder 3, a pressure regulator 4 installed in the holder 3, a driven member 5 pivoted to the holder 3, and a container 6 connected to and covered on the holder 3. When started, the driving mechanism 2 moves the driven member 5 and the show item (not shown) carried on the driven member 5.

The base 1 comprises a plurality of upright female mounting members 11, and a through hole 12 for the passing of the pressure regulator 4.

The driving mechanism 2 can be a hand-operated driving mechanism (for example, a musical box), or an electric-operated driving mechanism (for example, a motor), having an output shaft 21, a follower 23 fixedly fastened to the output shaft 21, and a plurality of actuating elements, for example, magnets 24 located on the follower 23. According to the embodiment shown in FIGS. 1, 2, and 5, the driving mechanism is a musical box, and the reference sign 22 indicates a handle adapted to fasten up the clockwork of the musical box.

The holder 3 is molded from transparent acrylics, comprising a platform 31, a top lug 32 protruded from the top center of the platform 31 for receiving the driven member 5, a circular holder shell 33 spaced around the platform 31, an inner thread 34 extended around the inner surface of the circular holder shell 33 for receiving the container 6, a vertical passage hole 35 for receiving the pressure regulator 4, and a plurality of bottom mounting rods 36 for fastening to the upright female mounting members 11 of the base 1.

The pressure regulator 4 comprises a connecting a connector 41 connected to the bottom end of the vertical passage hole 35 of the holder 3, a rubber bulb 42 connected to one end of the connector 41, and a through hole 411 extended through the connector 41 in air communication with the inside space of the rubber bulb 42 and the vertical passage hole 35.

The driven member 5 is pivoted to the lug 32 of the holder 3, having a plurality of actuating elements, for example, magnets 51 located on the bottom sidewall thereof. When the follower 23 rotated with the output shaft 21 of the driving mechanism 2, the magnets 24. of the driving mechanism 2 act with the magnets 51 of the driven member 5, thereby causing the driven member 5 to move up and down like a seesaw.

The container 6 is molded from transparent acrylics, comprising a spherical container body 61 adapted to hold a liquid, a neck 62 extended from (the open side of) the container body 61, and an outer thread 63 extended around the periphery of the neck 62 and threaded into the inner thread 34 of the holder 3.

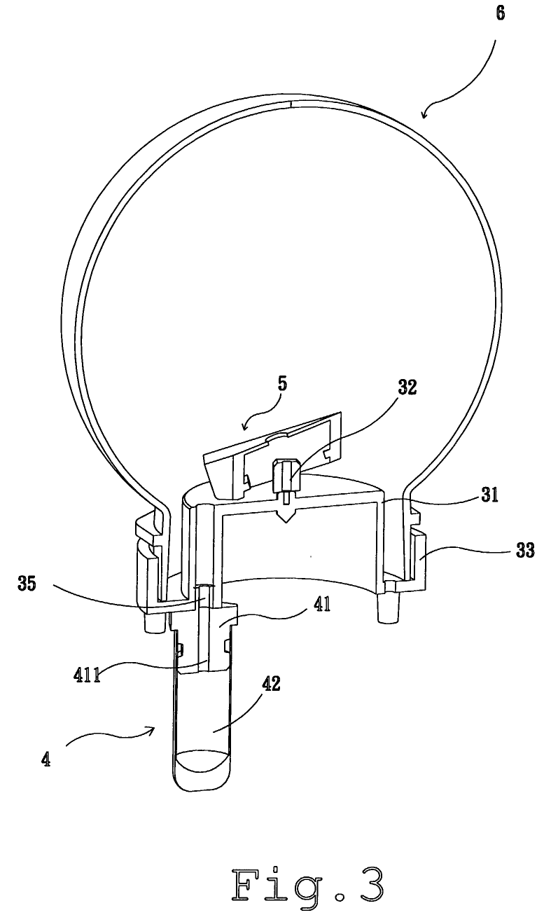

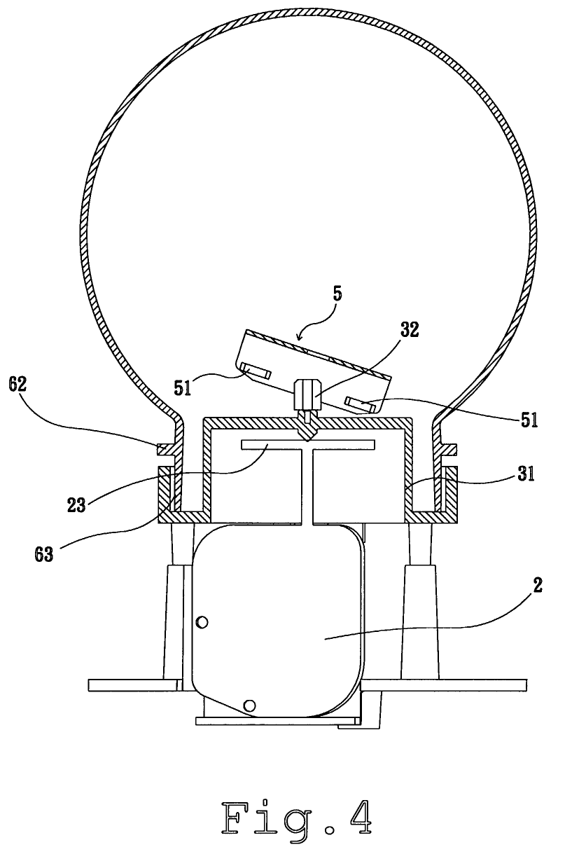

Referring to FIGS. 3 and 4, when the container 6 filled up with a liquid, the inner thread 34 of the holder 3 is threaded onto the outer thread 63 of the container 6, keeping the container 6 in a watertight status (gasket means or the like may be used to seal the connection area between the holder 3 and the container 6. When the output shaft 21 of the driving mechanism 2 rotated, the magnets 24 of the driving mechanism 2 are moved with the follower 23 relative to the magnets 51 at the driven member 5, thereby causing the driven member 5 to move up and down like a seesaw (due to magnetic attraction or repulsion between the magnets 24 of the driving mechanism 2 and the magnets 51 at the driven member 5). In case a musical box is used for the driving mechanism 2, it plays certain tunes in a mechanical manner when rotating the output shaft 21 and the follower 23.

Further, the rubber bulb 42 of the pressure regulator 4 automatically regulates the inside pressure of the container 6 when the inside pressure of the container 6 changed due to significant variation of ambient temperature during delivery of the ornamental motion display toy.

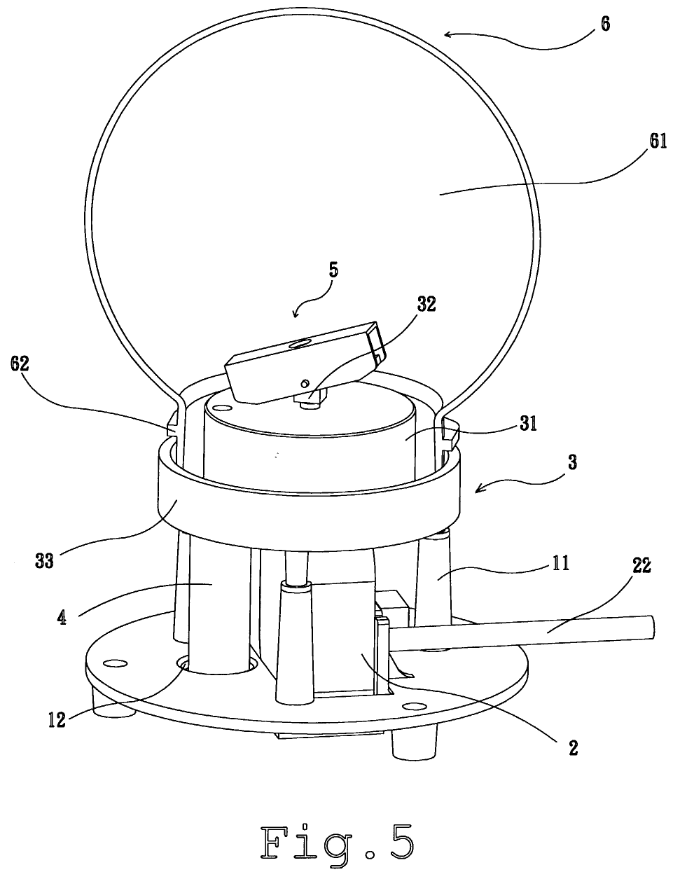

Referring to FIG. 5, the driven member 5 or the display item carried on the driven member 5 can be shaped like a character, landscape, plant, animal, etc. According to the present preferred embodiment, the driven member 5 and the lug 32 from a seesaw.

While only one embodiment has been shown and described, it will be understood that various modifications and changes could be made thereunto without departing from the spirit and scope of the invention disclosed. For example, light source means, for example, a decorating lamp set may be installed in the holder 3, and driven to produce a lighting effect when the driving mechanism 2 started.

What the invention claimed is:

1. An ornamental motion display toy comprising:
a base;
a driving mechanism located on said base, and adapted to rotate an output shaft thereof, said output shaft having a follower member and at least one actuating element fixedly provided at said follower member;
a holder mounted on said base, said holder comprising a platform, a passage hole, a lug at a top side of said platform, and a holder shell spaced around said platform;
a driven member pivoted to said lug of said holder, said driven member having at least one actuating member adapted to act with the at least one actuating member of said driving mechanism to move said driven member up and down when said output shaft and said follower rotated;
a container covered on said holder over said driven member, said container having a neck fastened to said holder shell of said holder in air communication with said passage hole; and
a pressure regulator connected to said passage hole of said holder and adapted to regulate the inside air pressure of said container.

2. The ornamental motion display toy as claimed in claim 1, wherein said base comprises a plurality of upright female mounting members respectively connected to said holder to support said holder above said base.

3. The ornamental motion display toy as claimed in claim 2, wherein said holder comprises a plurality of downwardly extended male mounting members respectively fastened to the upright female mounting members of said base.

4. The ornamental motion display toy as claimed in claim 1, wherein said base has a through hole for the passing of said pressure regulator.

5. The ornamental motion display toy as claimed in claim 1, wherein said holder and said container are respectively made of transparent acrylics.

6. The ornamental motion display toy as claimed in claim 1, wherein said driving mechanism is hand-operated.

7. The ornamental motion display toy as claimed in claim 6, wherein said driving mechanism is a musical box.

8. The ornamental motion display toy as claimed in claim 1, wherein said driving mechanism is electrically operated.

9. The ornamental motion display toy as claimed in claim 8, wherein said driving mechanism is a motor drive.

10. The ornamental motion display toy as claimed in claim 1, wherein said holder shell has an inner thread threaded onto the neck of said container.

11. The ornamental motion display toy as claimed in claim 1, wherein said holder has a light source installed therein.

12. The ornamental motion display toy as claimed in claim 11, wherein said light source is comprised of a decorating lamp set.

13. The ornamental motion display toy as claimed in claim 1, wherein the actuating elements of said driving mechanism and said driven member are magnets.

14. The ornamental motion display toy as claimed in claim 1, wherein said driven member has a display item carried thereon.

15. The ornamental motion display toy as claimed in claim 14, wherein said display item is a character.

16. The ornamental motion display toy as claimed in claim 14, wherein said display item is an animal.

17. The ornamental motion display toy as claimed in claim 14, wherein said display item is a plant.

18. The ornamental motion display toy as claimed in claim 1, wherein said pressure regulator comprises a connector fastened to a bottom end of said passage hole of said holder, a collapsible air bulb connected to said connector, and an air hole extended through said connector in communication between the inside space of said collapsible air bulb and said passage hole of said holder for enabling said collapsible air bulb to regulate the inside air pressure of said container.

19. The ornamental motion display toy as claimed in claim 18, wherein said collapsible air bulb is a rubber bulb.

20. The ornamental motion display toy as claimed in claim 1, wherein said neck of said container is a threaded neck threaded into the holder shell of said holder.
